(19) United States
(12) Patent Application Publication
(10) Pub. No.: US 2006/0133497 A1
(43) Pub. Date: Jun. 22, 2006

(54) Method and apparatus for encoding/decoding video signal using motion vectors of pictures at different temporal decomposition level

(76) Inventors: Seung Wook Park, Sungnam-si (KR); Ji Ho Park, Sungnam-si (KR); Byeong Moon Jeon, Sungnam-si (KR)

Correspondence Address: HARNESS, DICKEY & PIERCE, P.L.C., P.O. BOX 8910, RESTON, VA, 20195, US

(21) Appl. No.: 11/288,162

(22) Filed: Nov. 29, 2005

Related U.S. Application Data
(60) Provisional application No. 60/631,179, filed on Nov. 29, 2004.

(30) Foreign Application Priority Data
Mar. 30, 2005 (KR) 10-2005-0026799

(51) Int. Cl. H04N 11/02; H04N 7/12; H04N 11/04; H04B 1/66

(52) U.S. Cl. 375/240.16; 375/240.12

(57) ABSTRACT

A method and apparatus for encoding/decoding a video signal according to a scalable MCTF coding scheme is provided. When a video signal is encoded through a temporal decomposition procedure, information regarding a motion vector of an image block in an H frame in a frame sequence belonging to level L of the temporal decomposition procedure is recorded using information based on a motion vector of a block spatially co-located with the image block and present in an H frame belonging to level N (higher than the level L) of the temporal decomposition procedure. When the two motion vectors of the image block and the spatially co-located block are similar, the amount of coded motion vector information can be reduced, thereby increasing MCTF coding efficiency.

### PRIORITY INFORMATION

This application claims priority under 35 U.S.C. §119 on Korean Patent Application No. 10-2005-0026799, filed on Mar. 30, 2005, the entire contents of which are hereby incorporated by reference.

This application also claims priority under 35 U.S.C. §119 on U.S. Provisional Application No. 60/631,179, filed on Nov. 29, 2004; the entire contents of which are hereby incorporated by reference.

### BACKGROUND OF THE INVENTION

1. Field of the Invention

The present invention relates to scalable encoding and decoding of video signals, and more particularly to a method and apparatus for encoding a video signal according to a scalable Motion Compensated Temporal Filtering (MCTF) coding scheme using motion vectors of pictures at a different temporal decomposition level and a method and apparatus for decoding such encoded video data.

2. Description of the Related Art

It is difficult to allocate high bandwidth, required for TV signals, to digital video signals wirelessly transmitted and received by mobile phones and notebook computers, which are widely used, and by mobile TVs and handheld PCs, which it is believed will come into widespread use in the future. Thus, video compression standards for use with mobile devices must have high video signal compression efficiencies.

Such mobile devices have a variety of processing and presentation capabilities so that a variety of compressed video data forms must be prepared. This indicates that the same video source must be provided in a variety of forms corresponding to a variety of combinations of a number of variables such as the number of frames transmitted per second, resolution, and the number of bits per pixel. This imposes a great burden on content providers.

Because of these facts, content providers prepare high-bitrate compressed video data for each source video and perform, when receiving a request from a mobile device, a process of decoding compressed video and encoding it back into video data suited to the video processing capabilities of the mobile device before providing the requested video to the mobile device. However, this method entails a transcoding procedure including decoding and encoding processes, which causes some time delay in providing the requested data to the mobile device. The transcoding procedure also requires complex hardware and algorithms to cope with the wide variety of target encoding formats.

The Scalable Video Codec (SVC) has been developed in an attempt to overcome these problems. This scheme encodes video into a sequence of pictures with the highest image quality while ensuring that part of the encoded picture sequence (specifically, a partial sequence of frames intermittently selected from the total sequence of frames) can be decoded and used to represent the video with a low image quality. Motion Compensated Temporal Filtering (MCTF) is a scheme that has been suggested for use in the scalable video codec.

FIG. 1 illustrates a procedure for encoding a video signal according to a dyadic MCTF scheme in which alternating video frames selected from a given sequence of video frames are converted to H frames.

In FIG. 1, the video signal is composed of a sequence of pictures denoted by numbers. Each odd picture in the sequence is divided into macroblocks of a predetermined size. A prediction operation is performed for each macroblock of an odd picture with reference to adjacent even pictures to the left and right of the odd picture so that an error value corresponding to image differences (also referred to as a “residual”) of the macroblock from macroblocks in the adjacent even pictures, which are used as reference blocks of the macroblock, is coded into the macroblock, and motion vectors originating from the macroblock and extending to the reference blocks are determined and information of the determined motion vectors is also coded. In FIG. 1, each picture coded into an error value is marked ‘H’. The error value of the H picture is added to a picture having reference blocks, i.e., a reference picture used to obtain the error value. This operation is referred to as an update operation. In FIG. 1, each picture produced by the update operation is marked ‘L’. The prediction and update operations are performed for pictures (for example, pictures 1 to 16 in FIG. 1) in a given Group of Pictures (GOP), thereby obtaining 8H pictures and 8 L pictures. The prediction and update operations are repeated for the 8 L pictures, thereby obtaining 4H pictures and 4 L pictures. The prediction and update operations are repeated for the 4 L pictures, thereby obtaining 2H pictures and 2 L pictures. Such a procedure is referred to as temporal decomposition, and the Nth level of the temporal decomposition procedure is referred to as the Nth MCTF (or temporal decomposition) level, which will be referred to as level N for short.

As shown in FIG. 1, the temporal decomposition procedure is repeated on a GOP, for example, until one L picture is obtained. Data of all or part of the H pictures produced at all decomposition levels and the L picture obtained at the last decomposition level is provided as encoded video data of the GOP.

As described above, motion vectors of macroblocks of a picture are individually coded when the picture is coded into an H picture. Coding of the motion vectors affects the compression efficiency of the video signal since the amount of coded information of the motion vectors is considerable. Thus, there is a need to reduce the amount of coded information of motion vectors that are similar to each other.

### SUMMARY OF THE INVENTION

Therefore, the present invention has been made in view of the above circumstances, and it is an object of the present invention to provide a method and apparatus for encoding video in a scalable fashion, wherein motion vectors of a current picture encoded into an error value are coded using motion vectors of a picture at a different temporal decomposition level.

It is another object of the present invention to provide a method and apparatus for decoding a data stream including image blocks which have been encoded using motion vectors of a picture at a different temporal decomposition level.

It is yet another object of the present invention to provide a method and apparatus for encoding a video signal, wherein motion vectors of a current picture coded into an error value at the last temporal decomposition level is coded using motion vectors of another picture at the last level to which the error value has been added, and a method and apparatus for decoding a data stream having such coded motion vector information.

In accordance with the present invention, the above and other objects can be accomplished by the provision of a method and apparatus for encoding an input video signal through a temporal decomposition procedure, wherein information regarding a motion vector of an image block in a first frame, which has been coded into an error value and is present in a frame sequence belonging to an Lth level of the temporal decomposition procedure, is recorded using information based on a motion vector of a corresponding block spatially co-located with the image block and present in a second frame which has been coded into an error value and belongs to an Nth level different from the Lth level of the temporal decomposition procedure.

In an embodiment of the present invention, a motion vector of an image block present in a first frame, which has been coded into an error value and is present in a frame sequence belonging to an Nth level of the temporal decomposition procedure, is recorded using information based on a motion vector of a corresponding block spatially co-located with the image block and present in a second frame belonging to the Nth level, the second frame having a block to which an error value in the first frame has been added.

In an embodiment of the present invention, the Nth level is one level higher than the Lth level.

In an embodiment of the present invention, the second frame of the Nth level is a frame, which has been coded into an error value and is temporally closest to the first frame of the Lth level, in the frame sequence of the Nth level.

In an embodiment of the present invention, the information regarding the motion vector of the image block is recorded using the motion vector of the corresponding block in the second frame, if using the motion vector of the corresponding block is advantageous in terms of the amount of information.

In an embodiment of the present invention, the information regarding the motion vector of the image block is recorded using information indicating that the actual motion vector of the image block is identical to a derivative vector obtained from the motion vector of the corresponding block or is recorded using a difference vector between the derivative vector and the actual motion vector of the image block.

In an embodiment of the present invention, the derivative vector is obtained by multiplying the motion vector of the corresponding block by the ratio of time intervals between frames of different levels of the temporal decomposition procedure.

In an embodiment of the present invention, an L frame produced at the last level of the temporal decomposition procedure is coded into a P picture, and motion vector information obtained through this coding is used to obtain a motion vector of a block in an H frame of the same level (i.e., the last level).

In an embodiment of the present invention, when the temporal decomposition procedure is performed on a per GOP basis, an L frame produced at the last level of the temporal decomposition procedure of a current GOP is coded into a P picture using, as a reference frame, an L frame produced at the last level of the temporal decomposition procedure of the previous GOP.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates how a video signal is encoded according to an MCTF scheme;

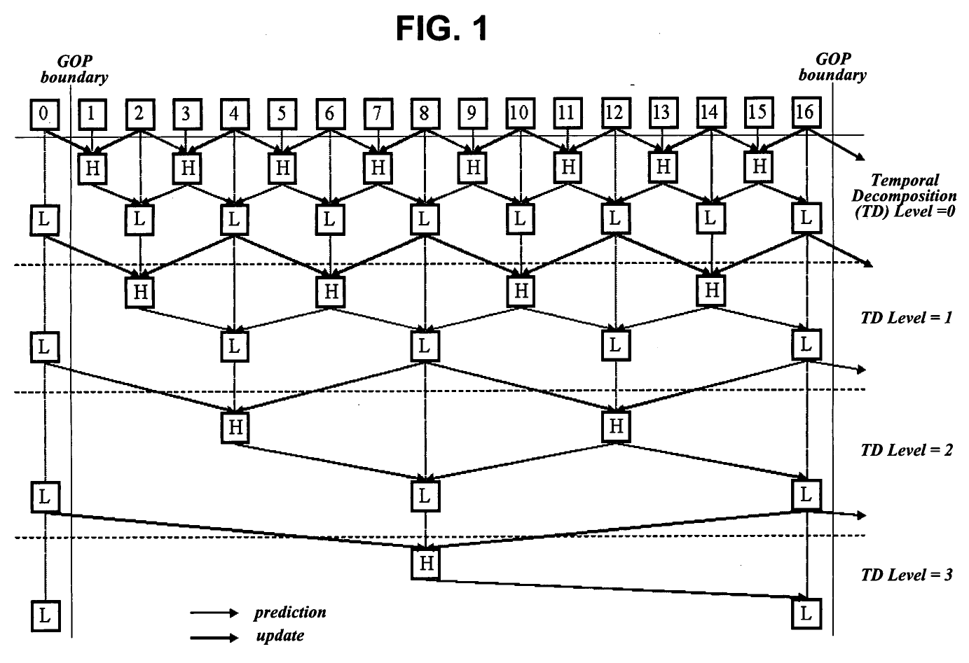

FIG. 2 is a block diagram of a video signal encoding apparatus to which a video signal coding method according to the present invention is applied;

FIG. 3 illustrates main elements of an MCTF encoder of FIG. 2 for performing prediction/estimation and update operations;

FIG. 4 illustrates how a video signal is encoded according to an MCTF scheme at a certain temporal decomposition level according to the present invention;

FIG. 5 illustrates how a video signal is encoded according to an MCTF scheme at the last temporal decomposition level according to the present invention;

FIG. 6 is a block diagram of an apparatus for decoding a data stream encoded by the apparatus of FIG. 2; and

FIG. 7 illustrates main elements of an MCTF decoder of FIG. 6 for performing inverse prediction and update operations.

### DESCRIPTION OF THE PREFERRED EMBODIMENTS

Preferred embodiments of the present invention will now be described in detail with reference to the accompanying drawings.

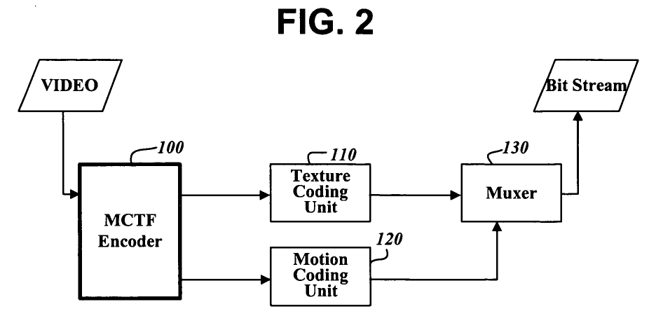

FIG. 2 is a block diagram of a video signal encoding apparatus to which a scalable video signal coding method according to the present invention is applied.

The video signal encoding apparatus shown in FIG. 2 comprises an MCTF encoder 100 to which the present invention is applied, a texture coding unit 110, a motion coding unit 120, and a muxer (or multiplexer) 130. The MCTF encoder 100 encodes an input video signal and generates suitable management information on a per macroblock basis according to an MCTF scheme. The texture coding unit 110 converts information of encoded macroblocks into a compressed bitstream. The motion coding unit 120 codes motion vectors of image blocks obtained by the MCTF encoder 100 into a compressed bitstream according to a specified scheme. The muxer 130 encapsulates the output data of the texture coding unit 110 and the output vector data of the motion coding unit 120 into a predetermined format. The muxer 130 then multiplexes and outputs the encapsulated data into a predetermined transmission format.

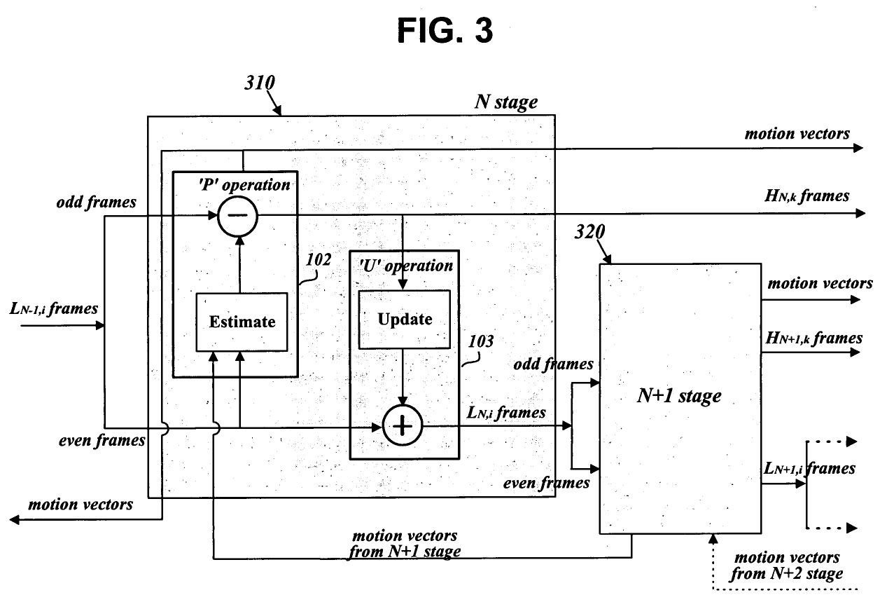

The MCTF encoder 100 performs motion estimation and prediction operations on each target macroblock in a video frame (or picture). The MCTF encoder 100 also performs an update operation by adding an image difference of the target macroblock from a reference macroblock in a reference frame to the reference macroblock. FIG. 3 is a block diagram of main elements of the MCTF encoder 100 for performing these operations.

The MCTF encoder 100 separates an input video frame sequence into frames, which are to be coded into error values, and frames, to which the error values are to be added, and then performs estimation/prediction and update operations on the separated frames a plurality of times (over a plurality of temporal decomposition levels). FIG. 3 shows elements associated with estimation/prediction and update operations at one of the plurality of temporal decomposition levels.

The elements of the MCTF encoder 100 shown in FIG. 3 include an estimator/predictor 102 and an updater 103. Through motion estimation, the estimator/predictor 102 searches for a reference block of each target macroblock of an odd (or even) frame, which is to be coded to residual data, in a neighbor frame prior to or subsequent to the odd (or even) frame. The estimator/predictor 102 then performs a prediction operation on the target macroblock in the odd (or even) frame by calculating both an image difference (i.e., a pixel-to-pixel difference) of the target macroblock from the reference block and a motion vector of the target macroblock with respect to the reference block. The updater 103 performs an update operation for a macroblock, whose reference block has been found in an even (or odd) frame by the motion estimation, by normalizing and adding the image difference of the macroblock to the reference block. The operation carried out by the updater 103 is referred to as a ‘U’ operation, and a frame produced by the ‘U’ operation is referred to as an ‘L’ frame. The ‘L’ frame is a low-pass subband picture. A detailed description of the U operation is omitted herein since it is known in the art.

The estimator/predictor 102 and the updater 103 of FIG. 3 may perform their operations on a plurality of slices, which are produced by dividing a single frame, simultaneously and in parallel instead of performing their operations on the video frame. A frame (or slice), which is produced by the estimator/predictor 102, is referred to as an ‘H’ frame (or slice). The difference value data in the ‘H’ frame (or slice) reflects high frequency components of the video signal. In the following description of the embodiments, the term ‘frame’ is used in a broad sense to include a ‘slice’, provided that replacement of the term ‘frame’ with the term ‘slice’ is technically equivalent.

More specifically, the estimator/predictor 102 divides each of the input video frames (or each L frame obtained at the previous level) into macroblocks of a predetermined size. Through inter-frame motion estimation, the estimator/predictor 102 codes each target macroblock of an input video frame, and directly determines a motion vector of the target macroblock with respect to the reference block. According to the present invention, the determined motion vector is not immediately provided to the motion coding unit 120. Instead, the determined motion vector is temporally stored and is then coded using a motion vector determined at the next decomposition level.

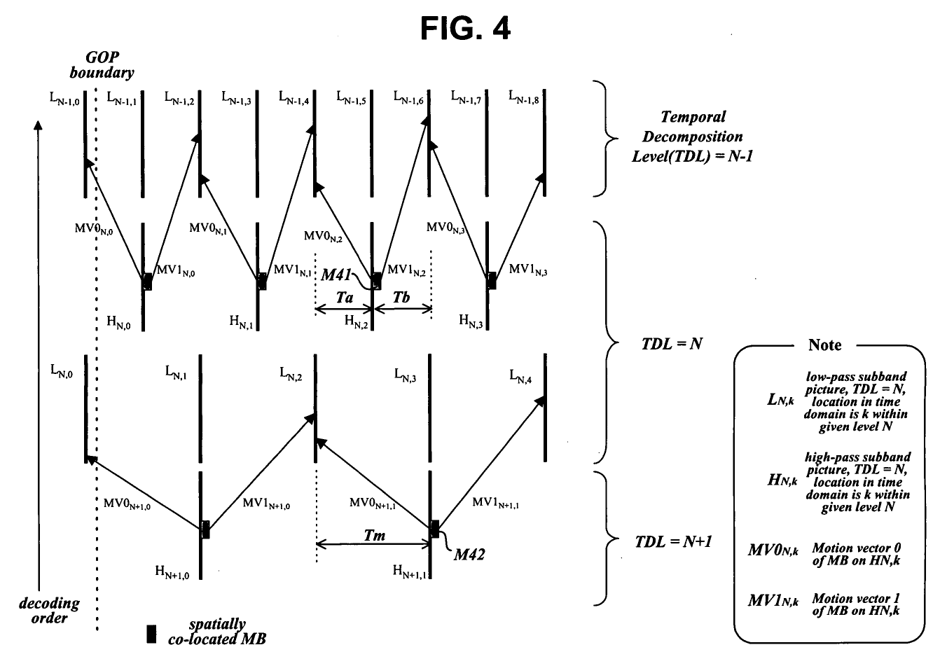

FIG. 4 illustrates how a video signal is encoded according to an MCTF scheme at a certain temporal decomposition level according to the present invention. In FIG. 4, the update operation is not shown and only the prediction operation is shown to avoid complicating the drawings. The above procedure will now be described in detail with reference to FIG. 4.

In the example of FIG. 4, when coding an odd L frame L_{N-1,2k+1} (or an input video frame) present at decomposition level N−1 into an H frame H_{N,k} having error values, an estimator/predictor 102 in a prediction/update block 310 for decomposition of a sequence of level N−1 searches adjacent frames prior to and/or subsequent to the odd L frame for a reference block most highly correlated with a target macroblock in the odd L frame, and codes an image difference of the target macroblock from the reference block into the target macroblock. Such an operation of the estimator/predictor 102 is referred to as a ‘P’ operation. The block most highly correlated with a target block is a block having the smallest image difference from the target block. The image difference of two image blocks is defined, for example, as the sum or average of pixel-to-pixel differences of the two image blocks. The block having the smallest image difference is referred to as a reference block. One reference block may be present in each of the reference frames and thus a plurality of reference blocks may be present for each target macroblock. The estimator/predictor 102 then obtains a motion vector MV0_{N,k} and/or MV1_{N,k} originating from the target macroblock and extending to the reference block. The estimator/predictor 102 temporally stores information of the obtained motion vector and then provides the information thereof to a prediction/update block (not shown) at the previous level unless the current level is the first decomposition level.

On the other hand, the updater 103 updates an L frame L_{N-1,2k}, which has not been coded into an H frame, and transmits the updated L frame to a prediction/update block 320 at the next level for decomposition of the next level. The prediction/update block 320 at the next level performs the above procedure on an input L frame sequence in the same manner, and provides information of motion vectors MV0_{N+1,j} and/or MV1_{N+1,j} obtained through the procedure to the estimator/predictor 102 at the previous level.

The estimator/predictor 102 at the previous level then codes motion vectors temporally stored at the previous level with reference to the motion vector information received from the prediction/update block 320 at the next level. This procedure will now be described in detail with reference to, as an example, the motion vector MV0_{N,k} and/or MV1_{N,k} temporally stored at the previous level.

First, from the motion vector information received from the prediction/update block 320 at the next level, the estimator/predictor 102 detects information of motion vectors MV0_{N+1,j} and/or MV1_{N+1,j} of a block M42, which is spatially co-located with a target macroblock M41 in a current frame H_{N,k} having motion vectors MV0_{N,k} and/or MV1_{N,k} and is present in an H frame H_{N+1,j} of the next decomposition level temporally closest to the current frame H_{N,k}. Here, “j” denotes the quotient of “k” divided by 2 and is also referred to as “k/2” (i.e., j=k/2). Then, the estimator/predictor 102 selects a motion vector, which spans a time interval including the current frame H_{N,k}, from the detected motion vectors MV0_{N+1,j} and/or MV1_{N+1,j} of the spatially co-located block M42. In the example of FIG. 4, the estimator/predictor 102 selects the motion vector MV0_{N+1,j} if k is even and selects the motion vector MV1_{N+1,j} if k is odd. Then, the estimator/predictor 102 calculates derivative vectors dmv0_{N,k} and dmv1_{N,k} corresponding to the detected motion vector information by Equations (1a) and (1b) or Equations (1a)′ and (1b)′. When k is even (j=k/2),
dmv0_{N,k}=MV0_{N+1,j}×Ta÷Tm (1a)
dmv1_{N,k}=−MV0_{N+1,j}×Tb÷Tm (1b)

When k is odd (j=k/2),
dmv0_{N,k}=−MV1_{N+1,j}×Ta÷Tm (1a)′
dmv1_{N,k}=MV1_{N+1,j}×Tb÷Tm (1b)′

where “Ta” and “Tb” denote the time differences between the current frame H_{N,k} including the target macroblock M41 having the motion vector MV0_{N,k} and/or MV1_{N,k} and frames, prior to and subsequent to the current frame H_{N,k}, including reference blocks of the target macroblock M41, and “Tm” denotes the time difference between the frame H_{N+1,j} including the spatially co-located block M42 having the motion vectors MV0_{N+1,j} and/or MV1_{N+1,j} and a frame including a reference block of the block M42 pointed to by one of the motion vectors MV0_{N+1,j} and/or MV1_{N+1,j}, which spans the current frame H_{N,k}.

As can be seen from Equations (1b) and (1a)′, if a target vector dmv1_{N,k} or dmv0_{N,k} to be derived from a motion vector MV0_{N+1,j} or MV1_{N+1,j} at the next decomposition level is in the opposite direction to the motion vector MV0_{N+1,j} or MV1_{N+1,j}, the estimator/predictor 102 calculates the derivative vector dmv1_{N,k} or dmv0_{N,k} after multiplying the motion vector MV0_{N+1,j} or MV1_{N+1,j} at the next decomposition level by −1 (i.e., after adding a negative sign (−) to the motion vector MV0_{N+1,j} or MV1_{N+1,j}).

If the derivative vectors dmv0_{N,k} and dmv1_{N,k} obtained in such a manner are identical to the actual motion vectors MV0_{N,k} and MV1_{N,k} which have been directly determined and temporally stored, the estimator/predictor 102 records simple information indicating that actual motion vectors of the target macroblock are identical to derivative vectors obtained from a motion vector of a corresponding block at the next decomposition level (or information indicating that the difference between the actual and derivative vectors is 0) in a header of the target macroblock M41. In this case, the estimator/predictor 102 does not transfer information of the actual motion vectors MV0_{N,k} and MV1_{N,k} to the motion coding unit 120 so that the actual motion vectors MV0_{N,k} and MV1_{N,k} are not coded.

If the derivative vectors dmv0_{N,k} and dmv1_{N,k} are different from the actual motion vectors MV0_{N,k} and MV1_{N,k} and if coding of the difference vectors MV0_{N,k}−dmv0_{N,k} and MV1_{N,k}−dmv1_{N,k} between the actual vectors and the derivative vectors is advantageous over coding of the actual vectors MV0_{N,k} and MV1_{N,k} in terms of, for example, the amount of data, the estimator/predictor 102 transfers the difference vectors to the motion coding unit 120 so that the difference vectors are coded by the motion coding unit 120, and records information, which indicates that the difference vectors between the actual vectors and the vectors derived from a spatially co-located motion vector at a higher decomposition level have been coded, in the header of the target macroblock MB41. For example, a flag “flag_predict_higher_level_mode” is defined and a value of the flag is set to, for example, “1” to indicate that a motion vector of a spatially co-located macroblock at the next decomposition level must be used to obtain motion vectors of the current macroblock. If coding of the difference vectors MV0_{N,k}−dmV0_{N,k} and MV1_{N,k}−dmv1_{N,k} is disadvantageous, the actual vectors MV0_{N,k} and MV1_{N,k} are provided to the motion coding unit 120 so that the actual vectors are coded thereby. After motion vectors of each macroblock in the current H frame are effectively determined in this manner and information necessary for the macroblock is recorded in a header of the macroblock, the picture, or the like, the H frame sequence is output to the texture coding unit 110 so that it is compressed.

The above procedure is repeated unless the current decomposition level is the last level. If the current decomposition level is the last level, motion vectors of an H frame produced at the last decomposition level are coded in a conventional manner or motion vector information of the H frame is coded using motion vectors of an L frame produced at the last decomposition level, depending on a data coding method employed for the L frame.

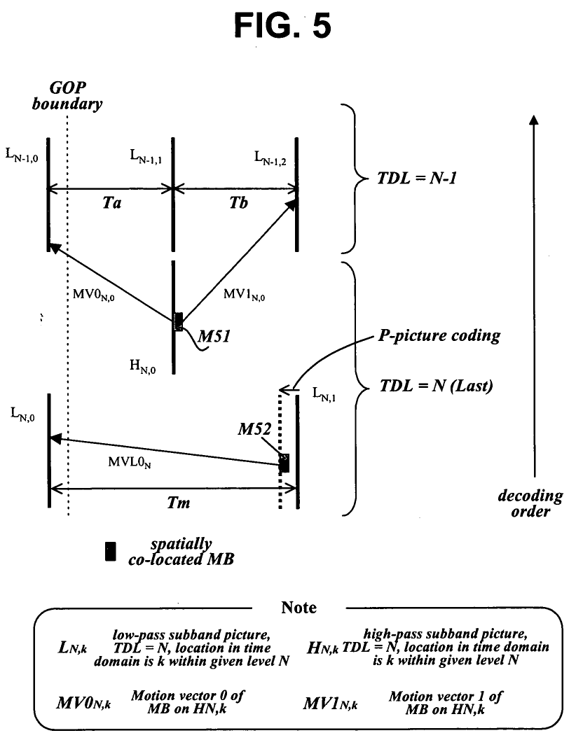

Specifically, in the case where an L frame produced at the last decomposition level (for example, an L frame produced per GOP) is transmitted without alteration, motion vectors of each macroblock in an H frame produced at the last decomposition level are determined according to the conventional method and the determined motion vector information is transmitted to the motion coding unit 120. On the other hand, in the case where an L frame produced at the last decomposition level is transmitted after being converted to a P picture containing error data with reference to data of an L frame produced at the last decomposition level of the previous GOP as illustrated in FIG. 5, motion vectors of each macroblock M51 in an H frame produced at the last decomposition level are coded using motion vector information of a spatially co-located macroblock M52 in the P picture.

More specifically, in the example of FIG. 5, first, derivative vectors of each macroblock M51 are calculated by substituting a motion vector MVLON of the corresponding block M52 in the P picture of the L frame of the same decomposition level, instead of the motion vector MV0_{N+1,j} of the next decomposition level, into Equations (1a) and (1b).

For example, if one L frame is produced for one GOP as illustrated in FIG. 5, derivative vectors dmv0_{N,0} and dvm1_{N,0} corresponding to motion vectors MV0_{N,0} and MV1_{N,0} of a target macroblock M51 in a current H frame H_{N,0} of the last decomposition level (level N in FIG. 5) are obtained by Equations (2a) and (2b).
dmv0_{N,0}=MV0_{N}×Ta÷Tm (2a)
dmv1_{N,0}=−MV0_{N}×Tb÷Tm (2b)

where “Ta” and “Tb” denote the time differences between the current frame H_{N,0} including the target macroblock M51 having the motion vector MV0_{N,0} and/or MV1_{N,0} and frames, prior to and subsequent to the current frame H_{N,0}, including reference blocks of the target macroblock M51, and “Tm” denotes the time difference between the last L frame L_{N,1} and an L frame L_{N,0} in an adjacent GOP having a reference block of a spatially co-located block M52 in a P picture of the last L frame L_{N,1}. As can be seen from Equation (2b), if a target vector dvm1_{N,0} to be derived from a motion vector MVLON at the last decomposition level is in a different direction from the motion vector MVL0_{N}, the derivative vector dvm1_{N,0} is obtained after multiplying the motion vector MVL0_{N} at the last decomposition level by −1 (i.e., after adding a negative sign (−) to the motion vector MVL0_{N}).

Then, as described above, if the obtained derivative vectors dmv0_{N,0} and dvm1_{N,0} are different from the actual motion vectors MV0_{N,0} and MV1_{N,0} and if coding of the difference vectors MV0_{N,0}−dmv0_{N,0} and MV1_{N,0}−dmv1_{N,0} between the actual vectors and the derivative vectors is advantageous over coding of the actual vectors MV0_{N,0} and MV1_{N,0} in terms of, for example, the amount of data, the difference vectors MV0_{N,0}−dmv0_{N,0} and MV1_{N,0}−dmv1_{N,0} are coded, and a flag “flag_predict_higher_level_mode” in a header of the target macroblock MB51 is set to, for example, 1. If coding of the difference vectors MV0_{N,0}−dmv0_{N,0} and MV1_{N,0}−dmv1_{N,0} is disadvantageous, the actual vectors MV0_{N,0} and MV1_{N,0} obtained for the target macroblock M51 are coded without alteration.

Instead of employing the above method wherein the way in which motion vectors at each temporal decomposition level are coded is determined after motion vectors at the next level are determined, the present invention may employ another method in which motion vectors at all temporal decomposition levels are determined, and, after the last temporal decomposition procedure is completed, it is determined whether or not motion vectors at each temporal decomposition level are to be coded into difference vectors obtained using motion vectors of the next level and then a motion vector coding procedure is completed. In this method, motion vectors of a picture of the highest level are initially coded, and motion vectors of pictures at the remaining levels are coded sequentially in order of decreasing level. Also in this case, difference vectors obtained using motion vectors of the higher level are coded if coding of the difference vectors is advantageous.

All or part of a data stream including L and H frames having vector information encoded in the method described above is transmitted by wire or Tirelessly to a decoding apparatus or is delivered via recording media. The decoding apparatus reconstructs the original video signal from the encoded data stream according to the method described below.

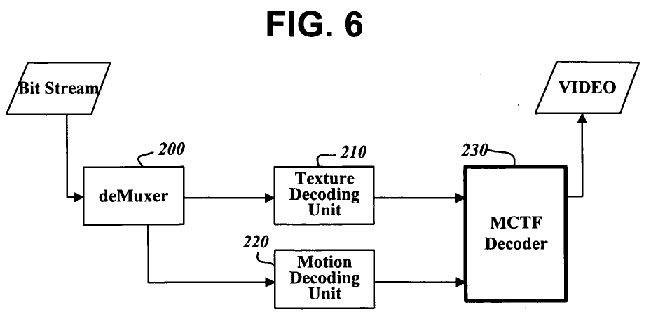

FIG. 6 is a block diagram of an apparatus for decoding a data stream encoded by the apparatus of FIG. 2. The decoding apparatus of FIG. 6 includes a demuxer (or demultiplexer) 200, a texture decoding unit 210, a motion decoding unit 220, and an MCTF decoder 230. The demuxer 200 separates a received data stream into a compressed motion vector stream and a compressed macroblock information stream. The texture decoding unit 210 reconstructs the compressed macroblock information stream to its original uncompressed state. The motion decoding unit 220 reconstructs the compressed motion vector stream to its original uncompressed state. The MCTF decoder 230 converts the uncompressed macroblock information stream and the uncompressed motion vector stream back to an original video signal according to an MCTF scheme.

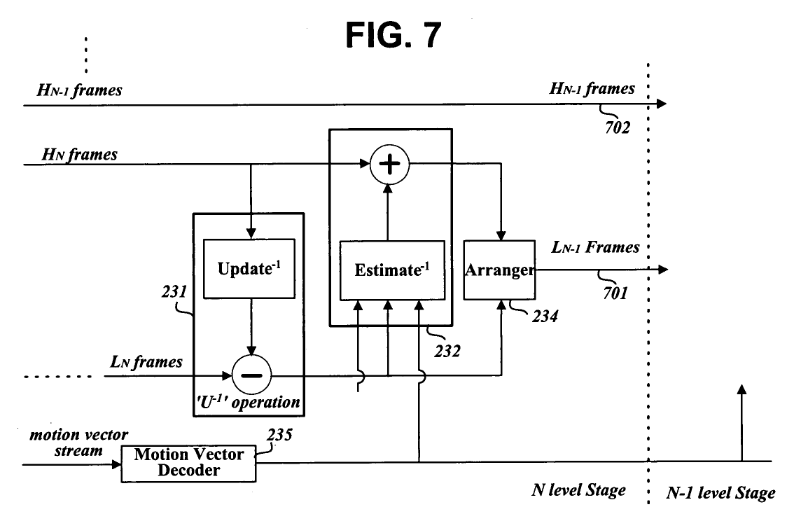

The MCTF decoder 230 includes elements as shown in FIG. 7 for reconstructing an original video frame sequence from an input stream.

FIG. 7 illustrates main elements of the MCTF decoder 230 responsible for reconstructing a sequence of H and L frames of MCTF level N to an L frame sequence of MCTF level N−1. The elements of the MCTF decoder 230 shown in FIG. 7 include an inverse updater 231, an inverse predictor 232, a motion vector decoder 235, and an arranger 234. The inverse updater 231 subtracts pixel difference values of input H frames from corresponding pixel values of input L frames. The inverse predictor 232 reconstructs input H frames to L frames having original images using the H frames and the L frames, from which the image differences of the H frames have been subtracted. The motion vector decoder 235 decodes an input motion vector stream into motion vector information of macroblocks in H frames and provides the motion vector information to an inverse predictor (for example, the inverse predictor 232) of each stage. The arranger 234 interleaves the L frames completed by the inverse predictor 232 between the L frames output from the inverse updater 231, thereby producing a normal sequence of L frames (or a final video frame sequence).

L frames output from the arranger 234 constitute an L frame sequence 701 of level N−1. A next-stage inverse updater and predictor of level N−1 reconstructs the L frame sequence 701 and an input H frame sequence 702 of level N−1 to an L frame sequence. If this decoding process is performed the same number of times as the number of MCTF levels employed in the encoding procedure, an original video frame sequence is obtained.

A more detailed description will now be given of how H frames of level N are reconstructed to L frames according to the present invention. First, for an input L frame, the inverse updater 231 subtracts error values (i.e., image differences) of macroblocks in all H frames, whose image differences have been obtained using blocks in the L frame as reference blocks, from the blocks of the L frame.

For each target macroblock of a current H frame, the inverse predictor 232 checks information regarding a motion vector of the target macroblock. If the information indicates that a motion vector of an H frame of a higher decomposition level must be used (i.e., if a flag “flag_predict_higher_level_mode” is 1), the inverse predictor 232 detects (or extracts) motion vector information of a corresponding block (i.e., a spatially co-located block) in an H frame of decomposition level N+1, which is temporally closest to the current H frame of current level N, from motion vector information provided from the motion vector decoder 235. The motion vector information of the corresponding block has already been decoded before the current decomposition level N is decoded. After detecting the motion vector information of the corresponding block, the inverse predictor 232 obtains derivative vectors dmv0_{N,k} and/or dmv1_{N,k} by Equations (1a) and/or (1b) or Equations (1a)′ and/or (1b)′. The inverse predictor 232 uses the obtained derivative vectors dmv0_{N,k} and/or dmv1_{N,k} as actual motion vectors MVONK and/or MV1_{N,k} of the target macroblock. Alternatively, the inverse predictor 232 obtains actual motion vectors MV0_{N,k} and/or MV1_{N,k} of the target macroblock by adding the obtained derivative vectors dmv0_{N,k} and/or dmv1_{N,k} to difference vectors MV0_{N,k}−dmv0_{N,k} and/or MV1_{N,k}−dmv1_{N,k} of the target macroblock provided from the motion vector decoder 235. Since the inverse predictor 232 cannot directly determine respective time intervals Ta and Tb between the current H frame including the target macroblock and frames including reference blocks of the target macroblock when applying Equations (1a) and/or (1b) or Equations (1a)′ and/or (1b)′, the inverse predictor 232 assumes, as the time intervals Ta and Tb, a time interval between the current H frame of decomposition level N and the H frame including the corresponding block of decomposition level N+1 and a time interval between the current H frame and a frame including a reference block of the corresponding block (i.e., Tm=Ta+Tb). Time information of each frame can be derived from information such as a frame rate included in a header of the GOP in the encoded stream.

If the level N of a current H frame to be decoded is the last decomposition level in the encoding procedure (i.e., the first decoding level), derivative vectors of a target macroblock in the current H frame are obtained by Equations (2a) and/or (2b) using motion vector information of a corresponding block (i.e., a spatially co-located block) in an L frame of the same decomposition level N which has been coded into a P picture, and the obtained derivative vectors are used to obtain actual motion vectors of the target macroblock.

The inverse predictor 232 determines a reference block, present in an adjacent L frame, of the target macroblock of the current H frame with reference to the actual vector derived from the motion vector of the corresponding block in the H frame of the higher decomposition level or in the L frame of the same decomposition level or with reference to the directly coded actual motion vector, and reconstructs an original image of the target macroblock by adding pixel values of the reference block to difference values of pixels of the target macroblock. Such a procedure is performed for all macroblocks in the current H frame to reconstruct the current H frame to an L frame. The arranger 234 alternately arranges L frames reconstructed by the inverse predictor 232 and L frames updated by the inverse updater 231, and provides such arranged L frames to the next stage.

The above decoding method reconstructs an MCTF-encoded data stream to a complete video frame sequence.

The decoding apparatus described above can be incorporated into a mobile communication terminal, a media player, or the like.

As is apparent from the above description, the present invention provides a method and apparatus for encoding and decoding a video signal according to an MCTF scheme, wherein motion vectors of blocks in pictures of a temporal decomposition level are coded using motion vectors of pictures of a higher temporal decomposition level, so that the amount of coded information of similar motion vectors can be reduced, thereby increasing MCTF coding efficiency.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for encoding a video signal through a temporal decomposition procedure, comprising:
an estimator/predictor for recording information regarding a motion vector of an image block in a first frame, which has been coded into an error value and is present in a frame sequence belonging to an Lth level of the temporal decomposition procedure, using information based on a motion vector of a corresponding block spatially co-located with the image block and present in a second frame which has been coded into an error value and belongs to an Nth level different from the Lth level of the temporal decomposition procedure.

2. The apparatus according to claim 1, wherein the Nth level is one level higher than the Lth level in the temporal decomposition procedure.

3. The apparatus according to claim 1, wherein the second frame is temporally closest to the first frame.

4. The apparatus according to claim 1, wherein the estimator/predictor additionally records information, indicating that the motion vector of the image block is to be obtained using the motion vector of the corresponding block, in a header of the image block.

5. The apparatus according to claim 1, wherein the information regarding the motion vector of the image block, recorded by the estimator/predictor, includes information indicating that the motion vector of the image block is identical to a derivative vector obtained from the motion vector of the corresponding block or information of a difference vector between the motion vector of the image block and the derivative vector.

6. The apparatus according to claim 5, wherein the derivative vector is obtained based on a product of the motion vector of the corresponding block and a ratio of a time interval between the first frame and a frame, present downstream of the first frame in a target derivative vector direction of the image block, to a time interval between the second frame and another frame including a block pointed to by the motion vector of the corresponding block.

7. The apparatus according to claim 6, wherein the derivative vector includes a derivative vector directed toward a frame prior to the first frame and/or a derivative vector directed toward a frame subsequent to the first frame.

8. The apparatus according to claim 6, wherein the estimator/predictor obtains the derivative vector by multiplying the product of the motion vector of the corresponding block and the ratio by −1 if the motion vector of the corresponding block and a target derivative vector direction of the image block are in different directions.

9. The apparatus according to claim 1, wherein the estimator/predictor records information regarding a motion vector of an image block present in a third frame, which has been coded into an error value and is present in a frame sequence belonging to a Pth level higher than the Nth level, using information based on a motion vector of a corresponding block spatially co-located with the image block and present in a fourth frame belonging to the Pth level, the fourth frame having a block to which an error value of at least one macroblock in the third frame has been added.

10. The apparatus according to claim 9, wherein the Pth level is a last level of the temporal decomposition procedure.

11. The apparatus according to claim 9, wherein the motion vector of the corresponding block is information obtained by coding data of the fourth frame into a frame containing error data with reference to a different frame.

12. The apparatus according to claim 11, wherein, when the video signal is divided into a plurality of intervals and the temporal decomposition procedure is performed for each of the plurality of intervals, the different frame belongs to the Pth level of the temporal decomposition procedure in an interval immediately prior to an interval including the fourth frame.

13. A method for receiving a bitstream encoded through a temporal decomposition procedure and decoding the bitstream into a video signal, the method comprising the steps of:
a) obtaining a motion vector of a target block in a first frame, which has been coded into an error value and is present in a frame sequence belonging to an Lth level of the temporal decomposition procedure in the bitstream, using a motion vector of a corresponding block spatially co-located with the target block and present in a second frame decoded from a picture having an error value belonging to an Nth level different from the Lth level of the temporal decomposition procedure; and
b) reconstructing error values of the target block to an original image, based on values of pixels of a reference block pointed to by the obtained motion vector of the target block.

14. The method according to claim 13, wherein the Nth level is one level higher than the Lth level in the temporal decomposition procedure.

15. The method according to claim 13, wherein the second frame is temporally closest to the first frame.

16. The method according to claim 13, wherein the step a) includes the step of obtaining the motion vector of the target block using a derivative vector obtained based on a product of the motion vector of the corresponding block and a ratio of a time interval between the first frame and the second frame or a time interval between the first frame and a frame including a block pointed to by the motion vector of the corresponding block to a time interval between the second frame and the frame including the block pointed to by the motion vector of the corresponding block, if information included in a header of the target block indicates that the motion vector of the corresponding block is to be used.

17. The method according to claim 16, wherein the derivative vector includes a derivative vector directed toward a frame prior to the first frame and/or a derivative vector directed toward a frame subsequent to the first frame.

18. The method according to claim 16, wherein the derivative vector is obtained by multiplying the product of the motion vector of the corresponding block and the ratio by −1 if the motion vector of the corresponding block and a target derivative vector direction of the target block are in different directions.

19. The method according to claim 13, wherein the step a) includes the step of obtaining a motion vector of a target block in a third frame, which has been coded into an error value and is present in a frame sequence belonging to a Pth level higher than the Nth level of the temporal decomposition procedure in the bitstream, using a motion vector of a corresponding block spatially co-located with the target block and present in a fourth frame belonging to the Pth level, the fourth frame having a block to which an error value of at least one macroblock in the third frame has been added.

20. The method according to claim 19, wherein the Pth level is a last level of the temporal decomposition procedure.
